(19) United States
(12) Patent Application Publication
(10) Pub. No.: US 2014/0049527 A1
(43) Pub. Date: Feb. 20, 2014

(54) DYNAMIC BACKLIGHT CONTROL WITH COLOR TEMPERATURE COMPENSATION

(71) Applicants: Thomas Lanzoni, Cedar Park, TX (US); Richard Schuckle, Austin, TX (US)

(72) Inventors: Thomas Lanzoni, Cedar Park, TX (US); Richard Schuckle, Austin, TX (US)

(73) Assignee: DELL PRODUCTS L.P., Round Rock, TX (US)

(21) Appl. No.: 13/585,892

(22) Filed: Aug. 15, 2012

(51) Int. Cl. G09G 3/36; G09G 5/10

(52) U.S. Cl. 345/207; 345/88; 345/102

(57) ABSTRACT

A display device comprises: a display screen, a pixel layer, a backlight, and at least one ambient light sensor (ALS) which detects ambient light around the display device. An Optimal Power and Color Adjustment Module (OPCAM) (a) receives detected ambient light information, (b) identifies characteristics of the ambient light, including brightness and color temperature, (c) selects a pre-calculated combination of power level and color details that collectively enables pre-determined acceptable display quality of images displayed on the display screen within the particular viewing space, and (d) respectively forwards the pre-calculated power level and color details to concurrently trigger the backlight drive current controller and the pixel layer controller to provide a specific amount of drive current to the backlight and specific color characteristics, including an amount of color intensity of the pixel layer, which collectively yields the pre-determined display image quality, while optimizing power usage by the display device.

### BACKGROUND

1. Technical Field

The present disclosure generally relates to display devices utilized with information handling system and in particular to providing improved power efficiency and color accuracy of display devices.

2. Description of the Related Art

As the value and use of information continue to increase, individuals and businesses seek additional ways to process and store information. One option available to users is information handling systems. An information handling system (IHS) generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems typically utilize a display device to provide visual output related to operations occurring within and/or being performed by the IHS. Depending on the type of system, the display device can be physically connected or affixed to the device or communicatively connected to the device via one or more cables and/or intermediary components, e.g., docking stations. Of the various types of display devices that can be provided with different information handling systems, perhaps the most common display devices in use today are liquid crystal display (LCD) panels, conventionally referred to as simply an LCD. LCDs are generally configured with a glass screen, a panel of (color) pixels coupled to a pixel layer controller, and a backlight that illuminates the pixels to create an image on the screen. The illumination of the pixel requires power (in the form of an applied voltage or current) to be applied to the backlight, and the level of illumination and/or the perceived brightness of the image is conventionally assumed to correlate to an amount of power (current) provided to the backlight from a power source associated with the LCD or with the associated information handling system. Manufacturers of LCDs and/or the devices that utilize the LCDs continually look for ways to reduce the amount of power consumed during presentation of images on an LCD, leading to an array of different power saving techniques that typically involve reducing the brightness of the backlight by reducing the amount of power applied.

### BRIEF SUMMARY

Disclosed are a display device and a method for displaying images on a display device that provides an improved backlight control with color temperature compensation. Also disclosed is an information handling system configured with a display device having similar functionality.

According to one embodiment, the display device comprises: a panel having a display screen disposed within a first surface; a pixel layer comprised of a plurality of color pixels positioned behind the display screen; a pixel layer controller communicatively coupled to the pixel layer and which controls color characteristics, including color intensity, of received images by selectively altering one or more of the pixels within the pixel layer to control an amount of backlight that passes through the pixels according to specified red, green and blue gain settings; at least one backlight located proximate to the pixel layer and which provides a light source that transmits/projects light through one or more of the plurality of color pixels to generate an image on the display screen; a backlight drive current controller that controls a level of drive current provided to the at least one backlight; and at least one ambient light sensor (ALS) which detects ambient light information within a particular viewing space around the display device. The display device further comprises an Optimal Power and Color Adjustment Module (OPCAM) which (a) receives the detected ambient light information from the ALS, (b) identifies characteristics of the ambient light including brightness and color temperature; (c) selects a pre-calculated combination of power level and color details that collectively enables pre-determined acceptable display quality of images displayed on the display screen while the display screen is exposed to the ambient light within the particular viewing space, while optimizing power usage by the display device, and (d) respectively forwards the pre-calculated power level and color details to concurrently trigger the backlight drive current controller and the pixel layer controller to provide a specific amount of drive current to the backlight and a specific set of color characteristics, including an amount of color intensity of the pixel layer. The drive current and color characteristics applied collectively yields the pre-determined acceptable display image quality, while optimizing power usage by the display device.

According to a next embodiment, a method comprises: detecting, via at least one ambient light sensor (ALS) disposed within a panel of a liquid crystal display (LCD), ambient light information corresponding to a particular viewing space (or ambient light space) surrounding the LCD; identifying characteristics of the detected ambient light information related to a light intensity and a color temperature of the ambient light; selecting a pre-calculated combination of power level and color details that collectively enables pre-determined acceptable display quality of images displayed by the LCD when the LCD is located within the particular viewing space, where the pre-calculated combination also optimizes power usage by the LCD; and concurrently forwarding the pre-calculated power level and color details to respectively trigger a backlight drive current controller and a pixel layer controller of the LCD to control a level of applied power provided to the backlight and color characteristics, including an amount of color intensity, of the pixel layer. The applied power level and amount of color intensity collectively yields the pre-determined acceptable display quality of color intensity and illumination for displayed images, while reducing power consumption by a backlight of the LCD and/or the LCD.

Yet another embodiment provides an information handling system comprising: a processor; a graphics processing unit (GPU); a power supply; a liquid crystal display (LCD) panel communicatively coupled to at least one of the processor and the GPU and which includes: a display screen disposed within a first surface; a pixel layer comprised of a plurality of color pixels positioned behind the display screen; a pixel layer controller communicatively coupled to the pixel layer and which controls color characteristics, including color intensity, of received images by selectively altering one or more of the pixels within the pixel layer to control an amount of backlight that passes through the pixels according to specified red, green and blue gain settings; at least one backlight located proximate to the pixel layer and which provides a light source that interacts with one or more of the plurality of color pixels to generate an image on the display screen; a backlight drive current controller that controls a level of drive current provided to the at least one backlight; and at least one ambient light sensor (ALS) which detects ambient light information within a particular viewing space (or ambient light space) around the LCD panel. The information handling system further comprises an Optimal Power and Color Adjustment Module (OPCAM) which (a) receives the detected ambient light information from the ALS, (b) identifies characteristics of the ambient light including brightness and color temperature; (c) selects a pre-calculated combination of power level and color details that collectively enables pre-determined acceptable display quality of images displayed on the display screen while the display screen is exposed to the ambient light within the particular viewing space, while optimizing power usage by the display device, and (d) respectively forwards the pre-calculated power level and color details to concurrently trigger the backlight drive current controller and the pixel layer controller to provide a specific amount of drive current to the backlight and specific color characteristics, including an amount of color intensity of the pixel layer, which collectively yields the pre-determined acceptable display image quality, while optimizing power usage by the display device.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates an example information handling system with a display device configured to enable dynamic backlight control with color temperature compensation, according to one or more embodiments;

FIG. 2 illustrates an example stand alone display device with components and logic that enable the dynamic backlight control functionality with color temperature compensation, in accordance with one or more embodiments;

FIG. 3 is a block diagram illustrating one example of the functional logic components with ambient light sensor feedback provided to an intermediate feedback analysis module, according to one or more embodiments;

FIG. 4 is a block diagram illustrating one example of the functional logic components with ambient light sensor feedback to both a backlight controller and a pixel processing controller, according to one or more embodiments; and

FIG. 5 (5A-5B) is a flow chart illustrating one embodiment of a method by which a display device processes detected ambient light information to dynamically control both display backlight intensity and color characteristics of displayed images, according to one or more embodiments.

### DETAILED DESCRIPTION

The illustrative embodiments provide a display device and a method for displaying images on a display device that provides an improved backlight control with color temperature compensation. Also disclosed is an information handling system configured with a display device having similar functionality. According to one embodiment, the display device comprises: a display screen, a pixel layer, a backlight, and at least one ambient light sensor (ALS) which detects ambient light information associated with a particular viewing space around the display device. The display device further comprises an Optimal Power and Color Adjustment Module (OPCAM) which (a) receives the detected ambient light information from the ALS, (b) identifies characteristics of the ambient light including brightness and color temperature; (c) selects a pre-calculated combination of power level and color details that collectively enables pre-determined acceptable display quality of images displayed on the display screen while the display screen is exposed to the ambient light within the particular viewing space (or ambient light space), while optimizing power usage by the display device, and (d) respectively forwards the pre-calculated power level and color details to concurrently trigger the backlight drive current controller and the pixel layer controller to provide a specific amount of drive current to the backlight and a specific set of color characteristics, including an amount of color intensity of the pixel layer, which collectively yields the pre-determined acceptable display image quality, while optimizing power usage by the display device.

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Various aspects of the disclosure are described from the perspective of an information handling system and a display device of, or for use with, an information handling system. For purposes of this disclosure, an information handling system, such as information handling system 100, may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a handheld device, personal computer, a server, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

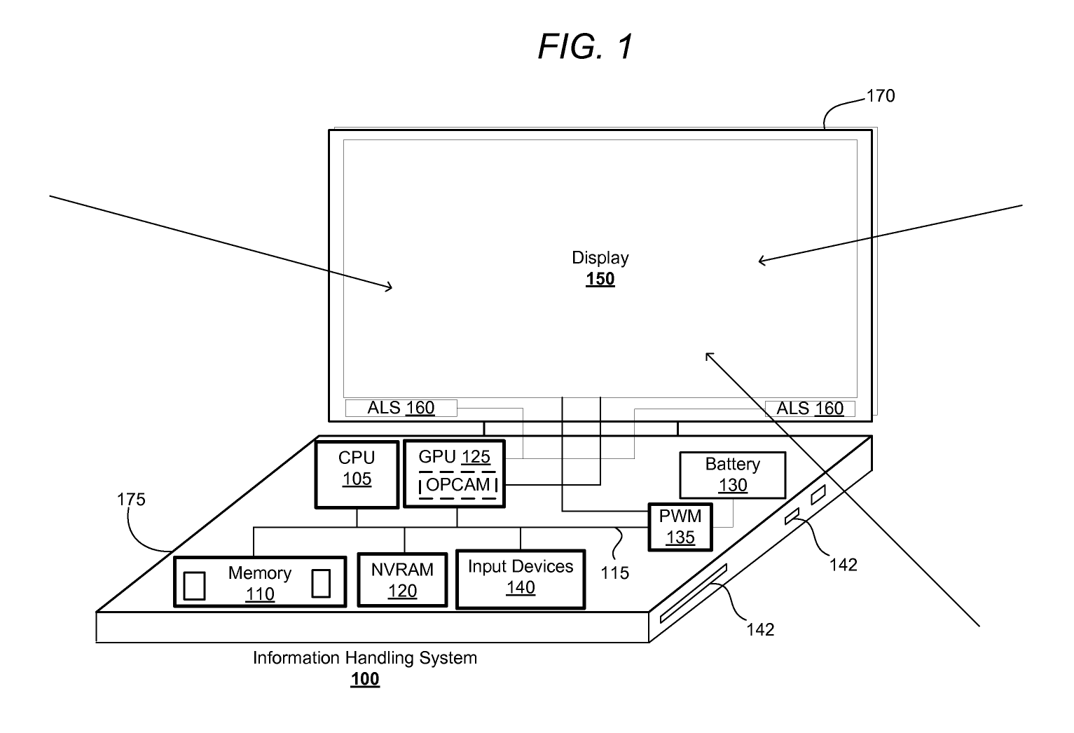

With reference now to the figures, and beginning with FIG. 1, there is depicted a block diagram representation of an example information handling system (IHS) 100, within which one or more of the described features of the various embodiments of the disclosure can be implemented. Information handling system 100 includes at least one central processing unit (CPU) 105 coupled to system memory 110 via system interconnect 115. Also coupled to CPU 105 via system interconnect 115 is a graphics card with a graphics processing unit (GPU) 125 located thereon. System interconnect 115 can be interchangeably referred to as a system bus, in one or more embodiments. Also coupled to system interconnect 115 is nonvolatile storage (NVRAM) 120, within which can be stored one or more software and/or firmware modules and one or more sets of data, such as configuration settings for image display, that can be utilized during operations of information handling system 100. These one or more software and/or firmware modules can be loaded into system memory 110 during operation of IHS 100. Specifically, in one embodiment, system memory 110 can include therein a plurality of such modules, including one or more of firmware (F/W), basic input/output system (BIOS), operating system (O/S), and application(s). These software and/or firmware modules have varying functionality when their corresponding program code is executed by CPU 105 or secondary processing devices, such as GPU 125, within information handling system 100. In one embodiment, one or more of these software-based modules can be utilized to configure image display settings and/or power management settings of information handling system 100. In order to operate the various electronic components, information handling system 100 requires a power supply, which can be provided via an external power source and/or an internal power source, such as battery 130. Use of the available power from the power source is moderated by power management module 135, which is coupled to each main component via a power bus to provide required power as well as perform other power-related administrative tasks of the information handling system 100.

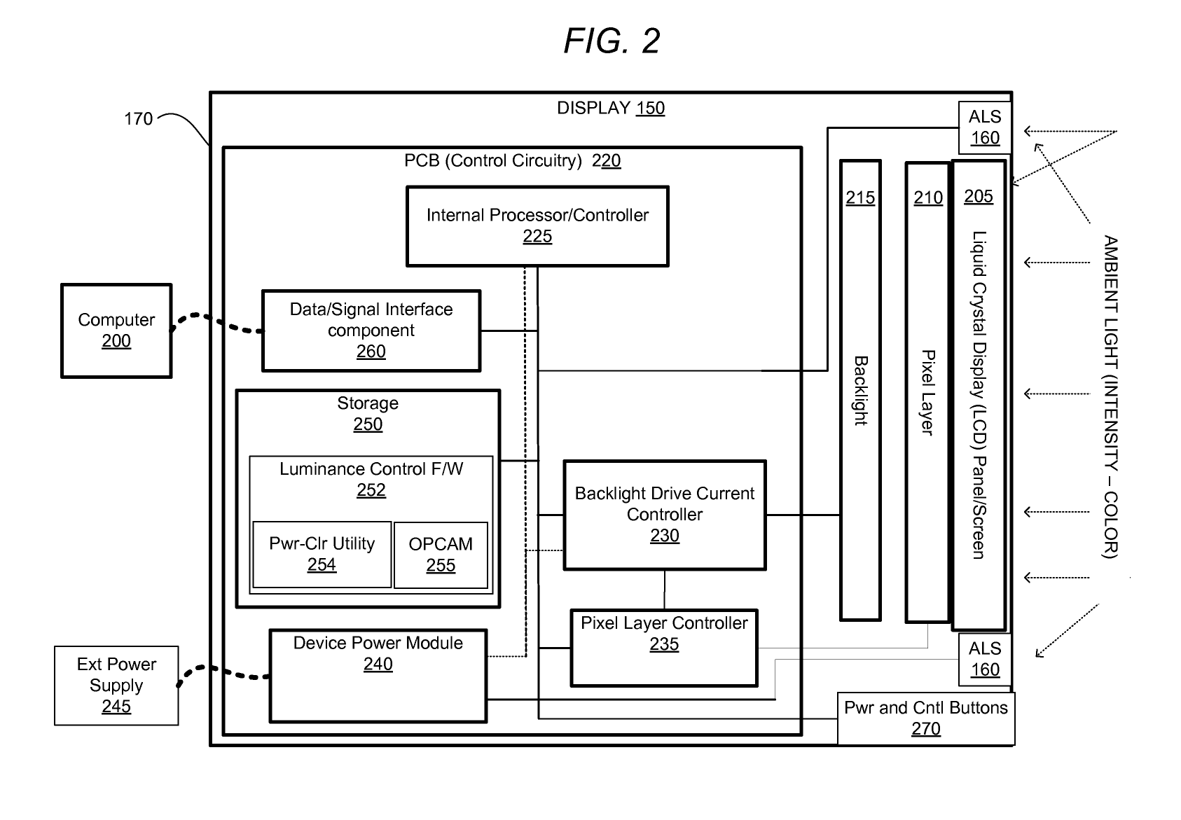

Information handling system 100 also comprises display device 150 having a liquid crystal display (LCD) panel communicatively coupled to at least one of the CPU 105 and the GPU 125 and which receives power allotment from PWM 135. Display device 150 can be an LCD having a backlight comprised of one of a plurality of white light emitting diodes (LEDs), RGB LEDs, Sequential RGB (SRGB) LEDs and a cool cathode florescent light (CCFL). Specific internal component makeup and configuration of display device 150 is described hereafter within the descriptions of FIGS. 2-4. As shown in FIG. 1, disposed within display device 150 are ambient light sensor(s) 160 which detect ambient light information associated with a particular viewing space around the LCD panel. The ambient light from the viewing space around the LCD panel is generally represented with the directional arrows terminating on the display screen.

The example information handling system is illustrated as a notebook computer or laptop, in which display device 150 includes a first housing 170 that is directly connected to a second, bottom housing 175 via a rotatable hinge mechanism. Thus, the first housing 170 is rotatably coupled to the second housing 175 by the hinge mechanism to create a top panel of a single physical device. According to the illustrative embodiment of FIG. 1, most of the above described processing components are generally housed within the second or bottom housing 175. Example information handling system of FIG. 1 thus comprises: a second (top) housing 175 within which is disposed each component of the information handling system 100 that is not within the first housing.

It is appreciated that the display device described within the various embodiments can be a display configured for use as a stand alone display device requiring a cable or other form of connection to a separate device or source that generates or provides the images and/or data for display on the display device. Additionally, the display device can also be an integral part of the actual electronic device, such as an LCD screen utilized with tablet computers, smartphones, and single integrated personal computing systems. Thus, in one or more alternate implementations, an information handling system can comprise a single housing that physically encases the LCD panel, the at least one backlight, and one or more additional components of the information handling system from among the processor, the GPU, the OPCAM, a backlight drive current controller, a pixel layer controller, and the power supply.

Example information handling system 100 also includes one or more input/output controllers which support connection of and processing of signals from one or more connected input device(s) 140, such as a keyboard, mouse, touch screen, or microphone and more connected output devices. As described in the remaining sections of the disclosure, the one or more connected output devices includes display device 150. In one embodiment, the information handling system 100 includes at least one input mechanism that enables input of specific display preferences, including at least one of a preferred power consumption level and a preferred color quality level, for the display device. Then, during image processing operations, the OPCAM can utilize the specific display preferences in determining which combination of power level and color details to select for displaying images on the display device within a current viewing space.

Additionally, in one or more embodiments, information handling system 100 can include one or more device interfaces 142, such as an optical reader, a universal serial bus (USB) port, a card reader, Personal Computer Memory Card International Association (PCMIA) slot, and/or a high-definition multimedia interface (HDMI). Device interface(s) 142 can be utilized to enable data to be read from or stored to corresponding removal storage device(s), such as a compact disk (CD), digital video disk (DVD), flash drive, or flash memory card.

Referring now to FIG. 2, there is illustrated a more detailed view of the component makeup of an example display device 150 configured to operate according to one or more embodiments of the present disclosure. Display device 150 comprises a panel, indicated as LCD panel 205, having a display screen (at front of panel), disposed within the panel. For simplicity, the combination of LCD panel with display screen shall be referenced herein as LCD screen 205. Display device 150 also includes a pixel layer 210 comprised of a plurality of color pixels positioned behind LCD screen 205, and display device 150 includes at least one backlight 215 located proximate to the pixel layer 210 and which provides a light source that interacts with one or more of the plurality of color pixels to generate an image on the LCD screen 205.

Display device 150 comprises one or more control circuit components, which perform various of the operations described herein to enable the display functionality described by the disclosure. In one embodiment, one or more of these control circuit components can be located on a printed circuit board (PCB) 220. Included in these control circuit components is internal processor/controller 225. Additionally, communicatively coupled to the pixel layer 210 is pixel layer controller 235 or pixel layer control circuit. Pixel layer controller 235 controls color characteristics, including color intensity, color temperature, color contrast, and the like, of displayed images by selectively altering one or more of the pixels within the pixel layer 210 to control an amount of backlight that passes through the pixels according to specified red, green and blue gain settings. In one or more embodiments, the images that are displayed can be images generated by image data received from computer 200 via data and signal interface component 260.

Display device 150 also comprises a backlight drive current controller 230 that controls a level of drive current forwarded to the at least one backlight 215. Backlight drive current controller 230 is coupled between backlight 215 and device power module 240, in one embodiment, for power management of display device. In one embodiment, backlight drive current controller 230 is coupled to and receives control input from an internal processor/controller 225 of display device 150 and/or from processing components within computer 200. Display device 150 also comprises at least one ambient light sensor (ALS) 160 which detects ambient light information within a particular viewing space (or ambient light space) around the display device and/or impinging on the LCD screen 205. ALS 160 is communicatively coupled to one or more processing components within the different control circuitry that can be located within display device 150. In an alternate embodiment, ALS 160 is communicatively coupled to processing components, such as GPU 125 and PWM 135 (FIG. 1), which can be located external to display device 150, e.g., on a connected computer 200.

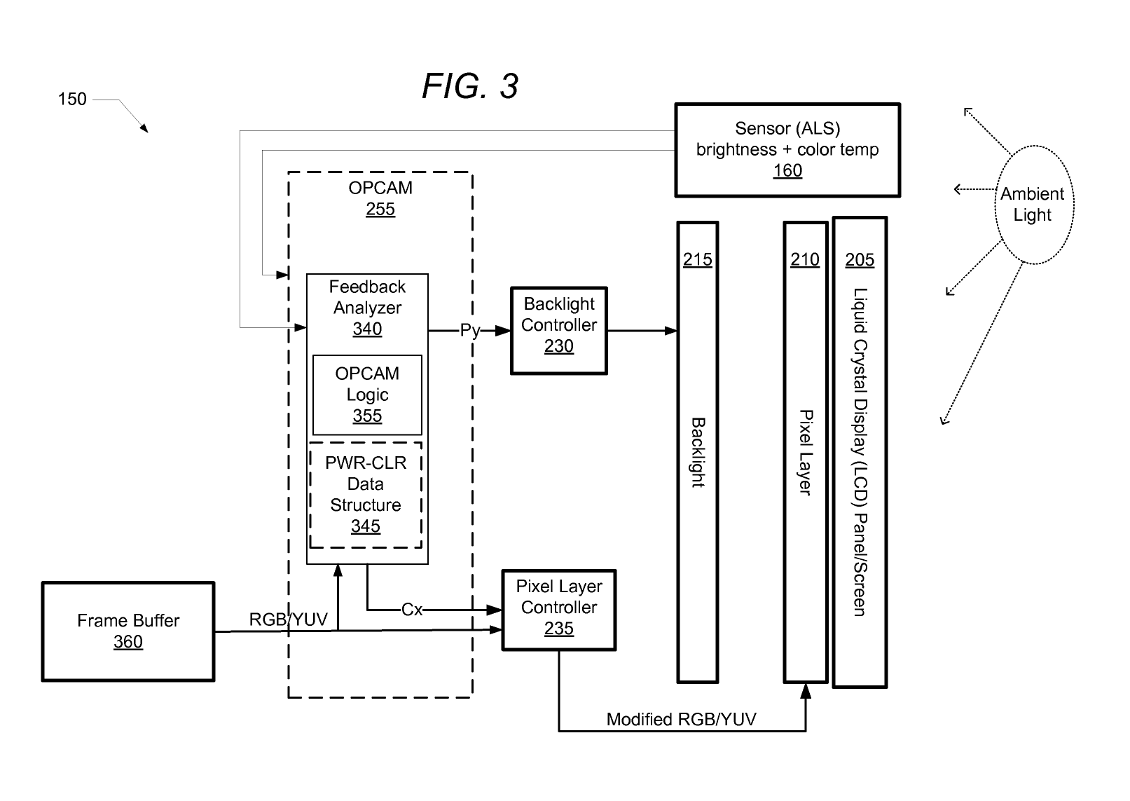

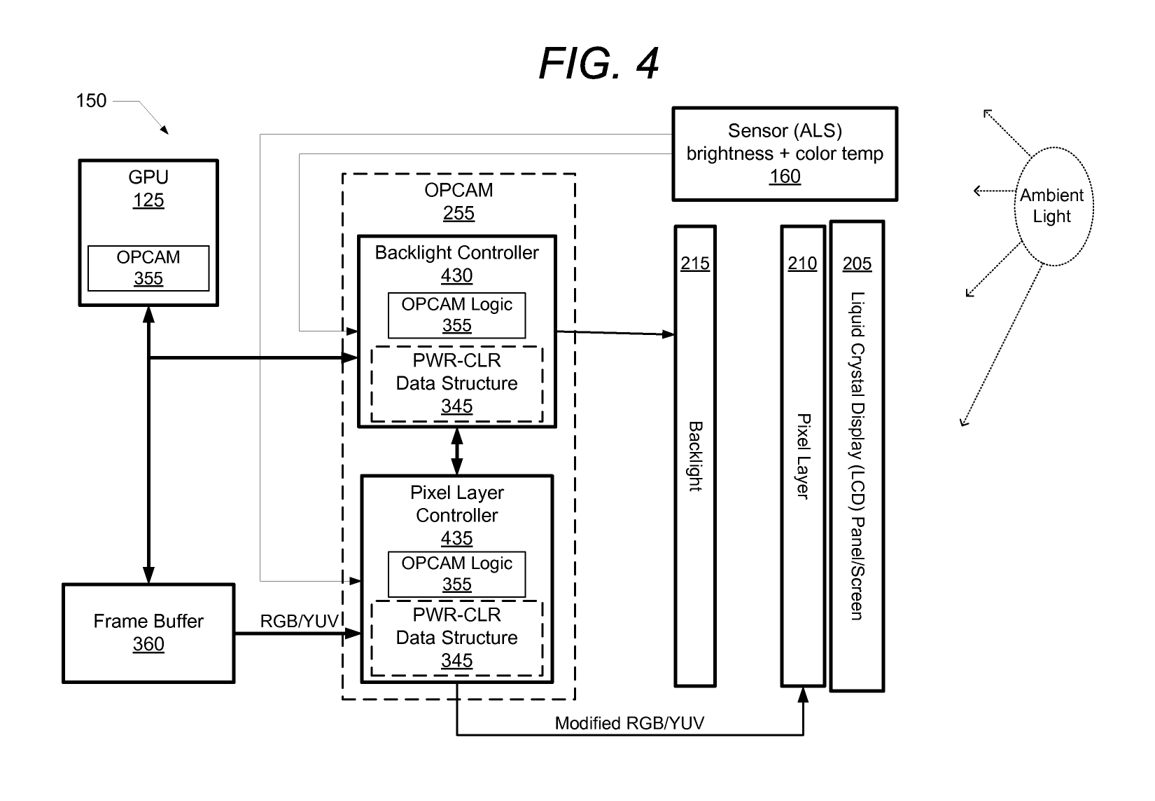

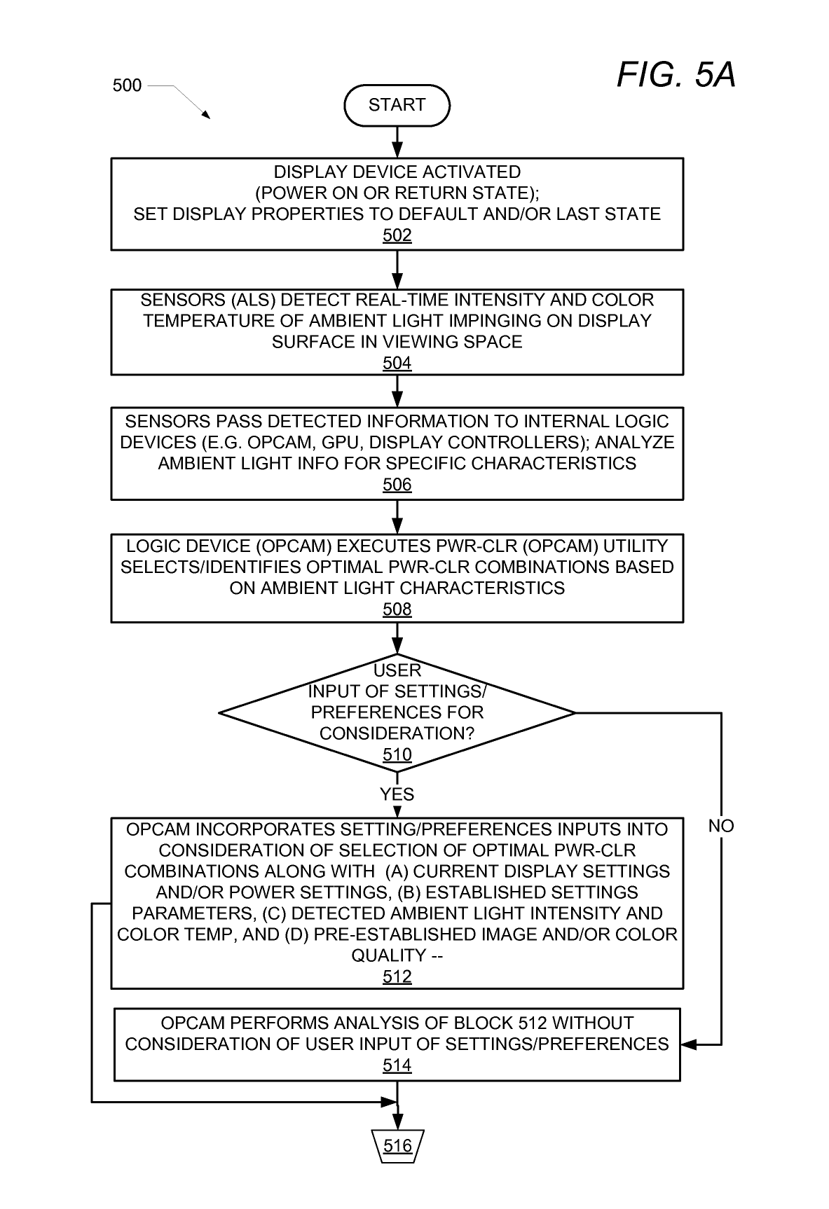

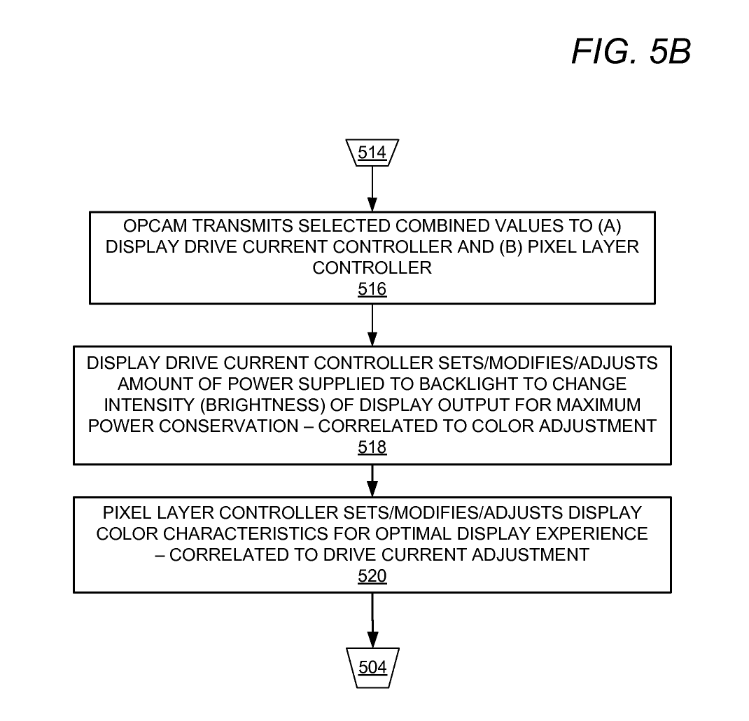

Display device 150 also comprises non-volatile storage 250 within which can be stored luminance control firmware 252, which includes a power and color combining utility 254 and according to one or more embodiments, an Optimal Power and Color Adjustment Module (OPCAM) 255. While illustrated in FIG. 2 as a firmware based module that exists within display device 150, it is appreciated that in alternate embodiments, OPCAM 255 can exist as a combination of hardware and firmware and can be located within other functional components of display 150 and/or of connected processing components. For example, as shown by the dashed lines in FIG. 1 and as presented by the different embodiments illustrated by FIGS. 3 and 4, OPCAM 255 can be a functional module within GPU 125 (FIGS. 1 and 3), or within backlight controller 230 and/or pixel layer controller 435 (FIG. 4), or within a stand alone module (FIG. 3). As presented herein, the term OPCAM 255 is intended to convey the functionality described herein, which is in part presented by the description of the flow chart of FIG. 5, and references to a specific configuration of components relative to the implementation of features attributed to OPCAM 255 are not intended to convey any limitations on disclosure. Thus, the various features described herein as functionality of OPCAM 255 can be implemented by existing control blocks of display device and/or the connected processing components. And, implementation of the functional aspects of the claimed subject matter and its equivalents, regardless of whether any reference is made to the term OPCAM, are understood to still fall within the scope of the disclosure.

According to the described embodiments, during image processing by display device 150, OPCAM 255: (a) receives the detected ambient light information from the ALS 160; (b) identifies characteristics of the ambient light including brightness and color temperature; (c) selects a pre-calculated combination of power level and color details that collectively enables a pre-determined acceptable display quality of images displayed on the display screen when within the particular viewing space, while optimizing power usage by the display device 150; and (d) respectively forwards the pre-calculated power level and color details to concurrently trigger the backlight drive current controller 230 and the pixel layer controller 235 to provide a specific amount of drive current to the backlight 215 and a specific set of color characteristics/details, including an amount of color intensity of the pixel layer 210. The amount of drive current and set of color characteristics collectively yields the pre-determined acceptable display quality of the displayed images, while optimizing power usage by the display device 150.

According to one aspect of the disclosure, OPCAM 255 selects the pre-calculated combination of power level and color details from among a plurality of pre-established combinations, which can be stored within a data structure or table maintained in a persistent storage of display device 150. Each pre-established combination supports the pre-determined acceptable display quality of images displayed on the display screen 205 when the display device 150 is located within a viewing space having pre-identified types of color and luminance characteristics associated with detected ambient light.

According to one aspect of the disclosure, display device 150 comprises at least one input mechanism that enables input of specific display preferences, including at least one of a preferred power consumption level and a preferred color quality level, for the display device. As illustrated by FIG. 2, the input mechanism can include power and control buttons 270 disposed within or on the display device 150. Alternatively, as described with FIG. 1, the one or more input mechanism can be associated with the input devices of the computer itself In response to or following receipt of input of specific display preferences, the OPCAM 255 utilizes the specific display preferences in determining which combination of power level and color details to select for displaying images on the display device 150 within a current viewing space.

In one alternate embodiment, OPCAM 255 comprises operational logic that: responsive to receipt of the ambient light information from the ALS 160 that indicates specific color and brightness characteristics that fall within one of a plurality of pre-established ranges, dynamically reduces a level of drive current to reduce an intensity of the backlight, while concurrently increasing a color level of an image being displayed to compensate for both: (a) a color of the ambient light; and (b) the reduction in the backlight intensity. Accordingly, an amount of power utilized by the backlight is decreased while providing the pre-determined acceptable display image quality.

Also, according to one embodiment, pixel layer controller 235 is communicatively coupled to and receives image data from a data and signal interface component 260 that receives visual display image data from one or more of graphical processing unit 125, CPU 105, and any other connected processing device/component executing software that generates the image data. Then, responsive to receipt of the pre-calculated color details from the OPCAM, the pixel layer controller 235 sets color details, including an amount of color intensity, that are applied to an image being generated from the received visual display image data.

As previously described, the display device 150 can be an LCD having a backlight comprised of one of a plurality of white light emitting diodes (LEDs), RGB LEDs, Sequential RGB (SRGB) LEDs and a cool cathode florescent light (CCFL). Within display device 150, backlight drive current controller 230 is coupled to a power source, external power supply 245, via device power module 240. Responsive to receipt of the pre-calculated power-level information from the OPCAM 255, the backlight drive current controller 230 sets a level of drive current that is forwarded to the backlight 215.

FIG. 3 provides a first alternate configuration of the functional logic components of display device 150 with ambient light sensor providing feedback to an intermediate feedback analysis module, feedback analyzer 340, of OPCAM 255. According to the presented embodiment of FIG. 3, OPCAM 255 is a separate module that includes a specific feedback analyzer 340 which is separate from but communicatively connected to backlight controller 230 and pixel layer controller 235. Feedback analyzer 340 includes OPCAM logic 355 and power and color mapping data structure 345. Feedback analyzer 340 and/or OPCAM 255 are communicatively coupled to ALS 160 and receive sensed/detected ambient light information from ALS 160. Feedback analyzer 340 and/or OPCAM 255 also received input from frame buffer 360 of RGB/YUV gain data for one or more images being scheduled for display on LCD screen 205 of display device 150. With the provided inputs and the pre-stored power and color combination data from data structure 345, feedback analyzer 340 is able to perform the above sequence of processes attributed to OPCAM 255. Feedback analyzer 340 then generates two outputs, a first power adjustment output (Py), which is forwarded to backlight drive current controller 230 and a second color details output (Cx), which is forwarded to pixel layer controller 235.

FIG. 4 provides a second alternate configuration of the functional logic components of display device 150, according to one embodiment. Within display device 150 of FIG. 4, both backlight controller 430 and pixel layer controller 435 are illustrated as components of OPCAM 255. ALS 160 is communicatively coupled to and provides feedback (ambient light information) to both backlight controller 430 and pixel layer controller 435. Backlight controller 430 and pixel layer controller 435 each contain OPCAM logic 355 and power and color mapping data structure 345, which are utilized by each of the controllers (430 and 435) to determine a best combination of color characteristics and drive current level to yield the required threshold quality of the display image, while minimizing power consumption by the display device 150. As further provided by FIG. 4, according to at least one embodiment, OPCAM logic 355 can be functional logic within GPU 125 and the processing of received ambient light information can occur within GPU 125.

Referring now to FIG. 5, there is illustrated a flow chart of the method for displaying images on an LCD display device (hereinafter LCD) and which provides improved backlight control with color temperature compensation. The method 500 begins at start block and proceeds to block 502 at which the LCD 150 is activated, either during a power on of the device or a return from sleep, hibernate, or screen saver mode. During the activation of LCD 150, the display properties (e.g., brightness and color details, such as color intensity, temperature, and contrast) are set to pre-established states or to a default or a last utilized state. Method 500 then includes detecting, via at least one ALS 160 disposed within a panel of the LCD 150, real-time ambient light information associated with a particular viewing space surrounding the LCD 150 (block 504). In one embodiment, the ambient light information includes intensity and color temperature of the ambient light impinging on the display screen 205. The detected ambient light information is received by one or more second devices (e.g., OPCAM 255) and analyzed (e.g., by feedback analyzer 340) to identify characteristics of the detected ambient light information related to light intensity and a color temperature of the ambient light (block 506). Once the specific information is identified, the method further includes OPCAM 255 automatically selecting (e.g., from data structure 345) a pre-calculated, pre-determined, and/or pre-evaluated combination of power level and color details that collectively enables pre-determined acceptable display quality of images displayed by the LCD 150 when the LCD 150 is located within the particular viewing space (block 508). According to one aspect of the disclosure, the pre-calculated combination also optimizes power usage by the LCD 150.

According to one embodiment, the pre-calculated combination of power level and color details is selected from among a plurality of pre-established combinations. According to one aspect of that embodiment, each pre-established combination supports the pre-determined acceptable display quality of images displayed on the display screen when the display device is located within a viewing space having pre-identified types of color and luminance characteristics associated with detected ambient light.

Also, in one alternate embodiment, the selecting of the specific combination is performed by a graphics processing unit (GPU) 125 communicatively coupled to the at least one ALS 160 and to the backlight drive current controller 230 and the pixel layer controller 235.

In the illustrated embodiment, the method 500 includes receiving one or more inputs of display settings/preferences related to at least one of a preferred power consumption level and a preferred color quality level, for the LCD 150. According to one aspect, the display settings can include factors from among brightness, power control, and color intensity, and color contrast. Also, the receipt of the display settings/preferences is not necessarily contemporaneous with the detection of the ambient light information, as the settings can be provided earlier in time and stored within the display device storage. In response to a determination (at block 510) that an input of display settings/preferences has been received and are to be included in the consideration of display settings by OPCAM 255, the method includes the OPCAM 255 incorporating information received via the one or more inputs of display settings/preferences into the selecting of the combination of parameters that are respectively applied to the backlight and the pixel layer of the LCD (block 512). Accordingly, with this embodiment, the specific display preferences are utilized in the determination of which combination of power level and color details are selected for displaying images on the display device located within a current viewing space. However, as provided at block 514, OPCAM 255 does not utilize the settings/parameters input within the analysis in response to user preferences not being considered.

With the completion (at block 512 and/or 514) of the identification and selection of the optimal pre-calculated combination for the particular display quality and detected ambient light, the method comprises concurrently forwarding the selected pre-calculated power level and color details to respectively trigger a backlight drive current controller 230 and a pixel layer controller 235 of the LCD 205 to control a level of applied power provided to the backlight 215 and applied color characteristics, including an amount of color intensity, of the pixel layer 210 (block 516). According to one aspect of the disclosure, the applied power level and amount of color intensity collectively yields the pre-determined acceptable display quality of color intensity and illumination for displayed images, while reducing power consumption by a backlight of the LCD.

As described above, and as illustrated by FIG. 4, the selecting can be performed by OPCAM 255, which can comprise the backlight drive current controller 430 and the pixel layer controller 435. The OPCAM 255 and specifically the backlight drive current controller 430 and the pixel layer controller 435 receives an input of the ambient light information from the least one ALS 160.

Returning to method 500, responsive to receipt of the selected combination, and particularly the pre-calculated power level, the backlight drive current controller sets an amount of drive current being forwarded to the backlight (block 518). Concurrently, the pixel layer controller receives image data from a data and signal interface component that receives visual display image data from one or more of a graphical processing unit, a central processing unit, and an image source such as a connected processing device executing software that generates the image (block 518). Responsive to receipt of the pre-calculated color details from the OPCAM 255, the method 500 comprises the pixel layer controller setting color details, including an amount of color intensity, that are applied to an image being generated from the received visual display image data (block 520). The process then returns to block 504 at which ambient light continues to be detected by ALS 160 and analyzed by OPCAM 255 to dynamically adjust color and brightness characteristics of the images being displayed on LCD 150 to continually provide the desired display quality, while minimizing power output by the LCD 150.

In the above described flow chart, one or more of the method processes may be embodied in a computer readable device containing computer readable code such that a series of steps are performed when the computer readable code is executed on a computing device. In some implementations, certain steps of the methods are combined, performed simultaneously or in a different order, or perhaps omitted, without deviating from the scope of the disclosure. Thus, while the method steps are described and illustrated in a particular sequence, use of a specific sequence of steps is not meant to imply any limitations on the disclosure. Changes may be made with regards to the sequence of steps without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object oriented programming language, without limitation. These computer program instructions may be provided to a processor of a general purpose computer, special purpose computer, such as a GPU, or other programmable data processing apparatus to produce a machine, such that the instructions, which execute via the processor of the computer or other programmable data processing apparatus, performs the method for implementing the functions/acts specified in the flowchart and/or block diagram block or blocks.

As will be further appreciated, the processes in embodiments of the present disclosure may be implemented using any combination of software, firmware or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible medium that can contain, or store a program for use by or in connection with an instruction execution system, apparatus, or device.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A display device comprising:
a panel having a display screen disposed within a first surface;
a pixel layer comprised of a plurality of color pixels positioned behind the display screen;
a pixel layer controller communicatively coupled to the pixel layer and which controls color characteristics, including color intensity, of received images by selectively altering one or more of the pixels within the pixel layer to control an amount of backlight that passes through the pixels according to specified red, green and blue gain settings;
at least one backlight located proximate to the pixel layer and which provides a light source that transmits light through one or more of the plurality of color pixels to generate an image on the display screen;
a backlight drive current controller that controls a level of drive current provided to the at least one backlight;
at least one ambient light sensor (ALS) which detects ambient light information within a particular viewing space around the display device; and
an Optimal Power and Color Adjustment Module (OPCAM) which (a) receives the detected ambient light information from the ALS, (b) identifies characteristics of the ambient light including brightness and color temperature; (c) selects a pre-calculated combination of power level and color details that collectively enables pre-determined acceptable display quality of images displayed on the display screen while the display screen is exposed to the ambient light within the particular viewing space, while optimizing power usage by the display device, and (d) respectively forwards the pre-calculated power level and color details to concurrently trigger the backlight drive current controller and the pixel layer controller to provide a specific amount of drive current to the backlight and a set of color characteristics, including a specific amount of color intensity, of the pixel layer, which collectively yields the pre-determined acceptable display image quality, while optimizing power usage by the display device.

2. The display device of claim 1, further comprising a housing that physically encases the display device, and wherein the display device is an LCD having a backlight comprised of one of a plurality of White light emitting diodes (LEDs), RGB LEDs, Sequential RGB (SRGB) LEDs and a cool cathode florescent light (CCFL).

3. The display device of claim 1, wherein the backlight drive current controller is coupled to a power source and responsive to receipt of the pre-calculated power-level information from the OPCAM, the backlight drive current controller sets a level of drive current that is forwarded to the backlight.

4. The display device of claim 1, wherein:
the pixel layer controller is coupled to and receives image data from a data and signal interface component that receives visual display image data from one or more of a graphical processing unit, a central processing unit, and a connected processing device executing software that generates the image; and
responsive to receipt of the pre-calculated color details from the OPCAM, the pixel layer controller sets color details, including an amount of color intensity, that are applied to an image being generated from the received visual display image data.

5. The display device of claim 1, wherein the OPCAM selects the pre-calculated combination of power level and color details from among a plurality of pre-established combinations, wherein each pre-established combination supports the pre-determined acceptable display quality of images displayed on the display screen when the display device is located within a viewing space having pre-identified types of color and luminance characteristics associated with detected ambient light.

6. The display device of claim 5, further comprising:
at least one input mechanism that enables input of specific display preferences, including at least one of a preferred power consumption level and a preferred color quality level, for the display device; and
wherein the OPCAM utilizes the specific display preferences in determining which combination of power level and color details to select for displaying images on the display device within a current viewing space.

7. The display device of claim 1, further comprising:
operational logic of the OPCAM that: responsive to receipt of the ambient light information from the ALS that indicates specific color and brightness characteristics that fall within one of a plurality of pre-established ranges, dynamically reduces a level of drive current to reduce an intensity of the backlight, while concurrently increasing a color level of an image being displayed to compensate for both (a) a color of the ambient light and (b) the reduction in the backlight intensity, wherein an amount of power utilized by the backlight is decreased while providing the pre-determined acceptable display image quality.

8. A method comprising:
detecting, via at least one ambient light sensor (ALS) disposed within a panel of a liquid crystal display (LCD), ambient light information associated with a particular viewing space surrounding the LCD;
identifying characteristics of the detected ambient light information related to a light intensity and a color temperature of the ambient light;
selecting a pre-calculated combination of power level and color details that collectively enables pre-determined acceptable display quality of images displayed by the LCD when the LCD is located within the particular viewing space, wherein the pre-calculated combination also optimizes power usage by the LCD; and
concurrently forwarding the pre-calculated power level and color details to respectively trigger a backlight drive current controller and a pixel layer controller of the LCD to control a level of applied power provided to the backlight and color characteristics, including an amount of color intensity, of the pixel layer, wherein the applied power level and amount of color intensity collectively yields the pre-determined acceptable display quality of color intensity and illumination for displayed images, while reducing power consumption by a backlight of the LCD.

9. The method of claim 8, wherein the selecting is performed by an optimal power and color adjustment module (OPCAM) which receives an input of the ambient light information from the least one ALS, and wherein the OPCAM comprises the backlight drive current controller and the pixel layer controller.

10. The method of claim 9, further comprising:
selecting the pre-calculated combination of power level and color details from among a plurality of pre-established combinations, wherein each pre-established combination supports the pre-determined acceptable display quality of images displayed on the display screen when the display device is located within a viewing space having pre-identified types of color and luminance characteristics associated with detected ambient light.

11. The method of claim 8, wherein the selecting is performed by a graphics processing unit (GPU) communicatively coupled to the at least one ALS and to the backlight drive current controller and the pixel layer controller.

12. The method of claim 8, further comprising:
receiving one or more inputs of display settings/preferences related to at least one of a preferred power consumption level and a preferred color quality level, for the display device, wherein the display settings include factors from among brightness, power control, and color intensity, and color contrast;
incorporating information received via the one or more inputs of display settings/preferences into the selecting of the combination of parameters that are respectively applied to the backlight and the pixel layer of the LCD, wherein the specific display preferences are utilized in determining which combination of power level and color details to select for displaying images on the display device located within a current viewing space.

13. The method of claim 8, wherein:
the LCD comprises a housing that physically encases at least the display panel and the backlight, and wherein the LCD has a backlight comprised of one of a plurality of White light emitting diodes (LEDs), RGB LEDs, Sequential RGB (SRGB) LEDs and a cool cathode florescent light (CCFL); and
the backlight drive current controller is coupled to a power source; and
the method further comprises responsive to receipt of the selected combination, the backlight drive current controller sets an amount of drive current being forwarded to the backlight.

14. The method of claim 8, wherein:
the pixel layer controller is coupled to and receives image data from a data and signal interface component that receives visual display image data from one or more of a graphical processing unit, a central processing unit, and a connected processing device executing software that generates the image; and
responsive to receipt of the pre-calculated color details from the OPCAM, the method comprises pixel layer controller setting color details, including an amount of color intensity, that are applied to an image being generated from the received visual display image data.

15. An information handling system comprising:
a processor;
a graphics processing unit (GPU);
a power supply;
a liquid crystal display (LCD) panel communicatively coupled to at least one of the processor and the GPU and which includes: a display screen disposed within a first surface; a pixel layer comprised of a plurality of color pixels positioned behind the display screen;
a pixel layer controller communicatively coupled to the pixel layer and which controls color characteristics, including color intensity, of received images by selectively altering one or more of the pixels within the pixel layer to control an amount of backlight that passes through the pixels according specified red, green and blue gain settings;
at least one backlight located proximate to the pixel layer and which provides a light source that transmits light through one or more of the plurality of color pixels to generate an image on the display screen;
a backlight drive current controller that controls a level of drive current forwarded to the at least one backlight;
at least one ambient light sensor (ALS) which detects ambient light information associated with a particular viewing space around the LCD panel; and
an Optimal Power and Color Adjustment Module (OPCAM) which: (a) receives the detected ambient light information from the ALS, (b) identifies characteristics of the ambient light including brightness and color temperature, (c) selects a pre-calculated combination of power level and color details that collectively enables pre-determined acceptable display quality of images displayed on the display screen while the display screen is exposed to the ambient light within the particular viewing space, while optimizing power usage by the display device, and (d) respectively forwards the pre-calculated power level and color details to concurrently trigger the backlight drive current controller and the pixel layer controller to provide a specific amount of drive current to the backlight and specific color characteristics, including an amount of color intensity, of the pixel layer, which collectively yields the pre-determined acceptable display image quality, while optimizing power usage by the display device.

16. The information handling system of claim 15, further comprising a first housing that physically encases the LCD panel, the at least one backlight, and one or more additional components of the information handling system from among the processor, the GPU, the OPCAM, the backlight drive current controller, the pixel layer controller, and the power supply, wherein the display device is an LCD having a backlight comprised of one of a plurality of White light emitting diodes (LEDs), RGB LEDs, Sequential RGB (SRGB) LEDs and a cool cathode florescent light (CCFL).

17. The information handling system of claim 15, further comprising:
a second housing within which is disposed each component of the information handling system that is not within the first housing, wherein the first housing is rotatably coupled to the second housing by a hinge mechanism to create a top panel of a single physical device.

18. The information handling system of claim 15, wherein:
the backlight drive current controller is coupled to the power source and responsive to receipt of the pre-calculated power-level information from the OPCAM, the backlight drive current controller sets a level of drive current that is forwarded to the backlight;
the pixel layer controller is coupled to and receives image data from a data and signal interface component that receives visual display image data from one or more of a graphical processing unit, a central processing unit, and a connected processing device executing software that generates the image; and
responsive to receipt of the pre-calculated color details from the OPCAM, the pixel layer controller sets color details, including an amount of color intensity, that are applied to an image being generated from the received visual display image data.

19. The information handling system of claim 15, wherein the OPCAM:
selects the pre-calculated combination of power level and color details from among a plurality of pre-established combinations, wherein each pre-established combination supports the pre-determined acceptable display quality of images displayed on the display screen when the display device is located within a viewing space having pre-identified types of color and luminance characteristics associated with detected ambient light; and
responsive to receipt of the ambient light information from the ALS that indicates specific color and brightness characteristics that fall within one of a plurality of pre-established ranges, dynamically reduces a level of drive current to reduce an intensity of the backlight, while concurrently increasing a color level of an image being displayed to compensate for both (a) a color of the ambient light and (b) the reduction in the backlight intensity, wherein an amount of power utilized by the backlight is decreased while providing the pre-determined acceptable display image quality.

20. The information handling system of claim 15, further comprising:
at least one input mechanism that enables input of specific display preferences, including at least one of a preferred power consumption level and a preferred color quality level, for the display device; and
wherein the OPCAM utilizes the specific display preferences in determining which combination of power level and color details to select for displaying images on the display device within a current viewing space.
